(19) United States
(12) Patent Application Publication
(10) Pub. No.: US 2006/0092388 A1
(43) Pub. Date: May 4, 2006

(54) OPTICAL PROJECTION APPARATUS

(76) Inventors: Chia-Chen Liao, Hsinchu (TW); Wei-Sheng Chang, Hsinchu (TW); Chu-Ming Cheng, Hsinchu (TW); Keng-Han Chuang, Hsinchu (TW); Loug-Sheng Liao, Hsinchu (TW); Sheng-Chieh Yang, Hsinchu (TW); Hsin-Jen Wang, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/161,617

(22) Filed: Aug. 10, 2005

(30) Foreign Application Priority Data
Nov. 2, 2004 (TW) 93133307

(51) Int. Cl. G03B 21/14

(52) U.S. Cl. 353/97

(57) ABSTRACT

An optical projection apparatus includes an illumination system, a projection lens unit, a reflective light valve, a first beam breaker and a second beam breaker. A light beam is provided by the illumination system. The projection lens unit and the reflective light valve are disposed on the transmission path of the light beam, and the reflective light valve is disposed between the illumination system and the projection lens unit. The first beam breaker and the second beam breaker are used to cut into the transmission path of the light beam from different directions to block a part of the light beam, and part of the light beam passes through the first beam breaker and the second beam breaker. The darker image projected by the optical projection apparatus has higher contrast and better uniformity.

### CROSS-REFERENCE TO RELATED APPLICATION

This application claims the priority benefit of Taiwan application serial no. 93133307, filed on Nov. 2, 2004. All disclosure of the Taiwan application is incorporated herein by reference.

### BACKGROUND OF THE INVENTION

1. Field of Invention

The present invention relates to an optical projection apparatus. More particularly, the present invention relates to an optical projection apparatus, which can project a darker image with higher contrast and better uniformity.

2. Description of Related Art

In recent years, the projection apparatus of cathode ray tube (CRT) with large volume and weight has been gradually replaced by the liquid crystal display projection apparatus and the digital light processing (DLP) projection apparatus. These products have the properties of being light and portable, and can be directly connected to digital products and project images for display. Under the situation that the manufacturers continuously provide cheaper and more competitive products with additional function, these products are not only used by company, school, and other public place for the briefing tools, but also for viewing video at home. Therefore, it is an important issue to increase the image quality of the projection apparatus so as to increase the competitiveness of the product.

As mentioned above, conventionally, a “Dynamic Black” technology is used to increase the image quality, wherein a movable beam breaker is added in the projection lens unit. This beam breaker can move according to the different brightness level of the image so as to change the contrast of the image, and further improve the image quality.

In FIG. 1, the conventional optical projection apparatus 100 includes an illumination system 110, a projection lens unit 120, a digital micro-mirror device (DMD), and a beam breaker 140. Wherein, the illumination system 110 has a light source 112, which can provide a light beam 112a. The projection lens unit 120 and the illumination system 110 are disposed on the transmission path of the light beam 112a. The DMD 130 is located between the illumination system 110 and the projection lens unit 120, and the beam breaker 140 is disposed in the projection lens unit 120. The beam breaker 140 can cut into transmission path of the light beam 112a to block a portion of the light beam 112a.

In the foregoing optical projection apparatus 100, the light beam 112 provided from light source 112 passes through the color wheel 114, the light integration rod 116 and the relay lens 118, and is reflected to the DMD 130 via the total internal reflection (TIR) prism 119. This DMD 130 has a plurality of micro mirrors (not shown). Wherein, the micro mirrors in the ON state reflect the light beam 112a to the projection lens unit 120, while the micro mirrors in the OFF state deflect the light beam 112a away from the projection lens unit 120. Then, the light beam 112a being reflected to the projection lens unit 120 is projected to screen 300 to form an image.

In FIG. 1 and FIG. 2, when the optical projection apparatus 100 projects a relatively darker image, the beam breaker 140 implemented in the projection lens unit 120 cuts into the transmission path of the light beam 112a, to block a portion of the light beam 112a. As a result, it can reduce the brightness of the darker image, so as to increase the contrast of the darker image.

However, since the beam breaker 140 only blocks one side of the light beam 120a, it causes the defect that one side of the projected image is darker, while the other side is brighter. In addition, the projection lens unit 120 needs to be cut, so as to allow the beam breaker 140 to move in the projection lens unit 120. Thus, if the cutting portion of the projection lens unit 120 is too large, then the structure of the projection lens unit 120 is destroyed, and the projection lens unit 120 is in risk to be broken. On the contrary, if the cutting portion of the projection lens unit 120 is too small, then the beam breaker 140 can just block a little portion of the light beam 112a. As a result, it cannot effectively increase the contrast of the darker image.

### SUMMARY OF THE INVENTION

One objective of the present invention is to provide an optical projection apparatus using two beam breakers so as to project a darker image with higher contrast and more uniformity.

Another objective of the present invention is to provide an optical projection apparatus having a light source with multiple output powers so as to project a darker image with higher contrast and more uniformity.

Still another objective of the present invention is to provide an optical projection apparatus using a light attenuator so as to project a darker image with higher contrast and more uniformity.

Still another objective of the present invention is to provide an optical projection apparatus having a beam breaker with multiple holes so as to project a darker image with higher contrast and more uniformity.

In accordance with the foregoing objectives and others, the present invention proposes an optical projection apparatus, including an illumination system, a projection lens unit, a reflective light valve, a first beam breaker, and a second beam breaker. Wherein, the illumination system is used to provide a light beam. The projection lens unit and the reflective light valve are disposed on the transmission path of the light beam, and the reflective light valve is located between the illumination system and the projection lens unit. In addition, the first beam breaker and the second beam breaker can cut into the transmission path from different directions, so as to respectively block a portion of the light beam, and allow the other portion of the light beam to pass.

The present invention further provides an optical projection apparatus, which includes an illumination system, a projection lens unit, a reflective light valve, and a beam breaker. Wherein, the illumination system includes a light source capable of providing a light beam, and the light source has multiple output powers. The projection lens unit and the reflective light valve are disposed on the transmission path of the light beam. The reflective light valve is located between the illumination system and the projection lens unit. In addition, the beam breakers are disposed in the projection lens unit, and the beam breakers can cut into the projection lens unit to block a portion of the light beam. During the period when the beam breakers cut into the projection lens unit, the light source outputs a first power. During the other period, the light source outputs a second power, and the second power is larger than the first power.

The present invention further provides an optical projection apparatus, which includes an illumination system, a projection lens unit, a reflective light valve, a beam breaker, and a light attenuator. Wherein, the illumination system is capable of providing a light beam. The projection lens unit and the reflective light valve are disposed on the transmission path of the light beam, and the reflective light valve is located between illumination system and the projection lens unit. In addition, the beam breaker is implemented on the projection lens unit, and the beam breaker can cut into the projection lens unit to block a portion of the light beam. In addition, the light attenuator is implemented in the illumination system and the light attenuator can cut into the transmission path of the light beam in the illumination system.

The present invention further provides an optical projection apparatus, which includes an illumination system, a projection lens unit, a reflective light valve, and a beam breaker. Wherein, the illumination system is capable of providing a light beam. The projection lens unit and the reflective light valve are disposed on the transmission path of the light beam, and the reflective light valve is located between illumination system and the projection lens unit. In addition, the beam breaker with multiple holes is implemented on the projection lens unit, and the beam breaker can cut into the projection lens unit, to block a portion of the light beam.

The present invention uses two beam breakers. During the period when optical projection apparatus projects a darker image, the two beam breakers can cut into the transmission path of the light beam from different directions, to block a portion of the light beam. Therefore, the optical projection apparatus of the present invention can project a darker image with higher contrast and better uniformity.

In addition, the present invention uses a light source with multiple output powers or a light attenuator in the optical projection apparatus. During the period when a darker image is projected, the intensity of the light beam incident to the projection lens unit is reduced. As a result, the beam breaker only needs to block a small portion of the light beam, resulting in the contrast of the darker image. In addition, since the blocked portion of the light beam is less, the uniformity of the darker image being projected is improved.

In addition, the present invention uses the beam breaker with the multiple holes, whereby a portion of the light beam can pass through the holes. Thus, not only the contrast of the darker image can be improved, but also the uniformity of the darker image can be increased.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram illustrating the structure of a conventional optical projection apparatus.

FIG. 2 is a schematic diagram showing the action of the conventional beam breaker.

FIG. 3 is a schematic diagram illustrating an optical projection apparatus according to a preferred embodiment of the present invention.

FIG. 4A and FIG. 4B are schematic drawings illustrating the action of two beam breakers according to the preferred embodiment of the present invention.

FIG. 5A and FIG. 5B are schematic drawings illustrating the implementation of the beam breaker in FIG. 3 at the other locations.

FIG. 6 is a schematic drawing illustrating the structure of an optical projection apparatus according to another preferred embodiment of the present invention.

FIG. 7 is a schematic drawing illustrating the structure of the beam breaker according to a preferred embodiment of the present invention.

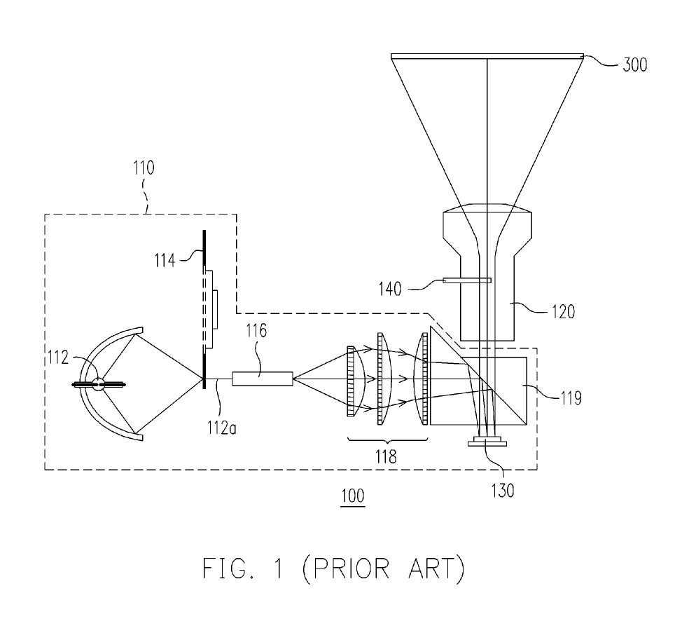

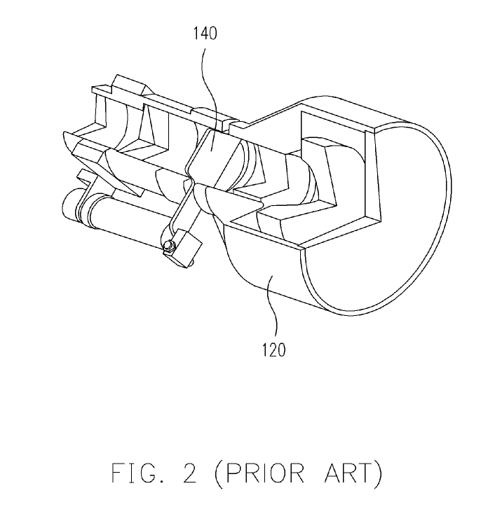

### DESCRIPTION OF THE PREFERRED EMBODIMENTS

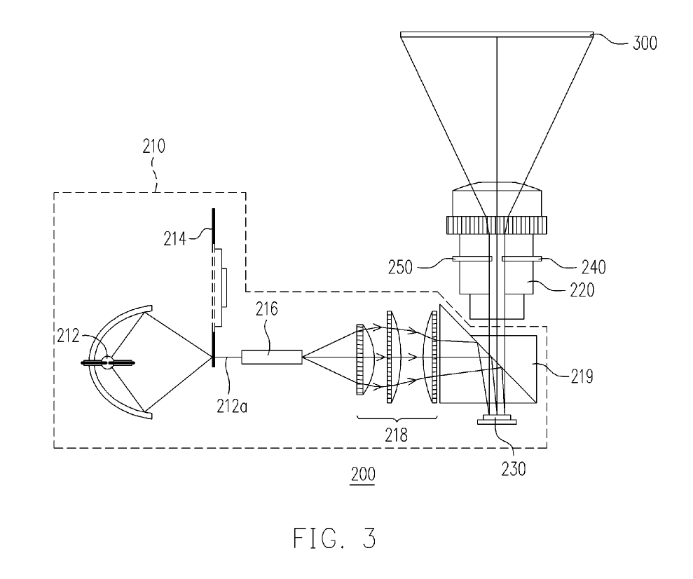

In FIG. 3, an optical projection apparatus 200 in one embodiment of the present invention includes an illumination system 210, a projection lens unit 220, a reflective light valve 230 and two beam breakers 240 and 250. Wherein, the illumination system 210 has a light source 212 capable of providing a light beam 212a. The projection lens unit 220 and reflective light valve 230 are disposed on the transmission path of the light beam 212a, and the reflective light valve 230 is located between the illumination system 210 and the projection lens unit 220. In addition, the two beam breakers 240 and 250 are disposed in the projection lens unit 220, and the two beam breakers 240 and 250 can cut into the transmission path of the light beam 212a so as to respectively block a portion of the light beam 212a and allow the other portion of the light beam 212a to pass.

In the foregoing optical projection apparatus 200, the light beam 212a provided from the light source 212 sequentially passes through the color wheel 214, the light integration rod 216, and the relay lens 218. Then, a total internal reflection prism 219 reflects light beam 212a to the reflective light valve 230. The reflective valve 230 can be a DMD or a LCOS panel. In the embodiment, the DMD is taken as an example. The DMD has a plurality of micro mirrors (not shown), in which the micro mirrors in the ON state can reflect the light beam 212a to the projection lens unit 220, and the micro mirrors in the OFF state can deflect the light beam 212a away from the projection lens unit 220. Then, the light beam 212a reflected to the projection lens unit 220 is projected to a screen 300 to form an image.

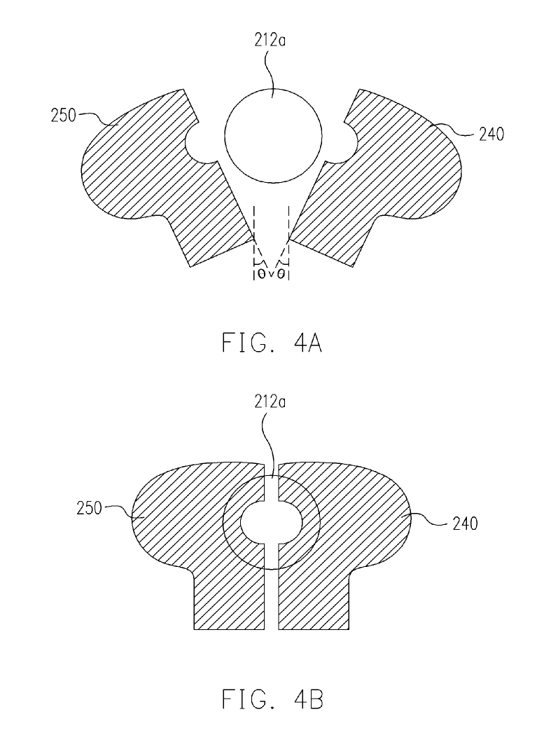

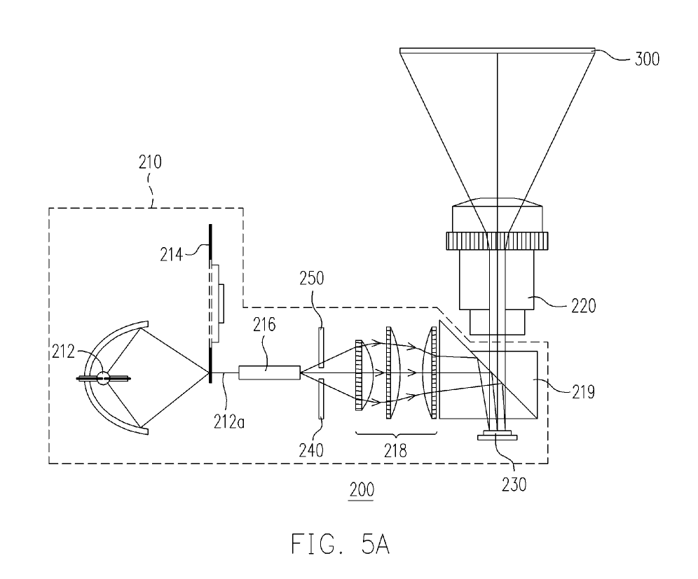

In FIG. 3 and FIG. 4A, when the optical projection apparatus 200 projects a whiter image, the first beam breaker 240 and the second beam breaker 250 implemented in the projection lens unit 220 do not block the light beam 212a. On the contrary, in FIG. 3 and FIG. 4B, when the optical projection apparatus 200 projects a darker image, the first beam breaker and the second beam breaker 240 and 250 implemented in the projection lens unit 220 respectively rotate an angle θ (shown in FIG. 4A) and cut into the transmission path of the light beam 212a to block a portion of the light beam 212a and let the other portion of the light beam 212a pass.

As described above, when the optical projection apparatus 200 projects the darker image, a portion of the light beam 212a is blocked so that the brightness for the darker image can be reduced and thereby the contrast of the darker image is improved. In addition, since the two beam breakers 240 and 250 cut in from different directions, the occurrence of the darker image with a larger brightness on one side thereof and a smaller brightness on the other side thereof is reduced. As a result, the uniformity of the darker image can be increased. In addition, since the embodiment uses two beam breakers 240 and 250, which simultaneously block a portion of the light beam 212a so that the angle θ for cutting in the projection lens unit 220 is not necessary to be large, and the objective of significantly increasing the contrast is achieved. Therefore, the cutting portion of the projection lens unit 220 is less, and the risk of being broken is reduced.

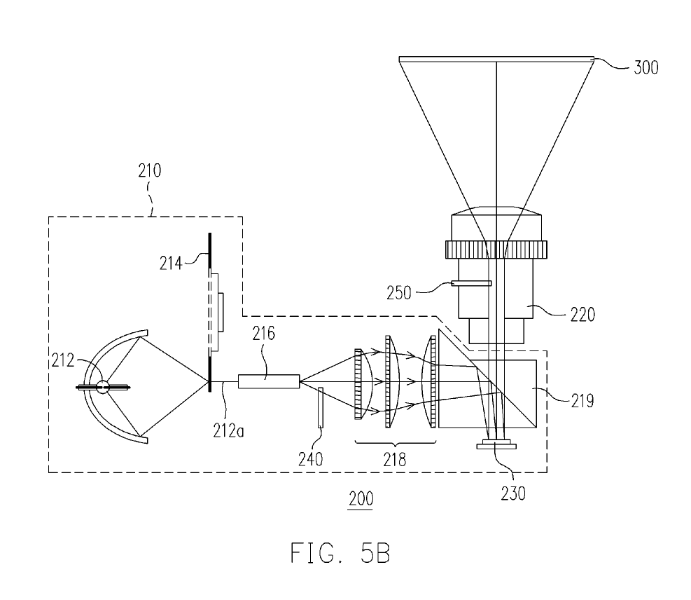

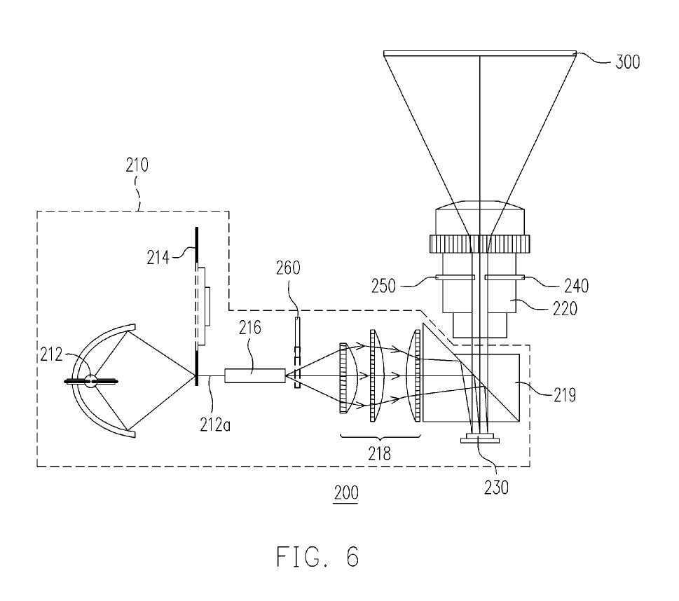

In FIG. 5A, the foregoing beam breakers 240 and 250 can be simultaneously implemented in the illumination system 210. In FIG. 5A, the two beam breakers 240 and 250 are disposed between the light integration rod 216 and the relay lens 218. However, the two beam breakers 240 and 250 can also be simultaneously or separately disposed between the color wheel 214 and the light integration rod 216, in the relay lens 218, between the total internal reflection prism 219 and the reflective light valve 230, or between the total internal reflection prism 219 and the projection lens unit 220.

In addition, referring to FIG. 5B, the foregoing beam breakers 240 and 250 can be respectively implemented in the illumination system 210 and the projection lens unit 220. The beam breaker 240 in FIG. 5B is disposed between the light integration rod 216 and the relay lens 218. However, the beam breaker 240 can also be disposed between the color wheel 214 and the light integration rod 216, in the relay lens 218, between the total internal reflection prism 219 and the reflective light valve 230, or between the total internal reflection prism 219 and the projection lens unit 220.

Referring to FIG. 3 again, in one embodiment of the present invention, the light source 212 of the illumination system 210 can be the light source capable of outputting several different powers. During a period when beam breakers 240 and 250 cut into the transmission path of the light beam 212a from different directions, the light source 212 outputs a first power. During the other period, the light source 212 outputs a second power, and the second power is larger than the first power. In other words, when the optical projection apparatus 200 projects a whiter image, the light source 212 emits a light beam 212a with stronger intensity. When the optical projection apparatus 200 projects a darker image, the light source 212 emits the light beam 212a with less intensity. In this manner, the angle θ (shown in FIG. 4A) for the beam breakers 240 and 250 to cut into the projection lens unit 220 becomes smaller, so that the risk of breaking the projection lens unit 220 is less. In addition, since the portion of the light beam 212a being blocked by the beam breakers 240 and 250 is less, the uniformity of the darker image can be improved.

Referring to FIG. 6, in the foregoing optical projection apparatus 200, a light attenuator 260 can be implemented in the illumination system 210. When the optical projection apparatus 200 projects the whiter image, the light attenuator 260 is located aside from the transmission path of the light beam 212a. On the contrary, when the optical projection apparatus 200 projects the darker image, the light attenuator 260 cuts into the transmission path of the light beam in the illumination system 210 so as to reduce the transmission of light beam 212a. In other words, the light beam 212a becomes weak when passing through the light attenuator 260. As a result, the angle θ (shown in FIG. 4A) for the beam breakers 240 and 250 to cut into the projection lens unit 220 becomes further smaller, so that the projection lens unit 220 is not easily broken. In addition, since the portion of the light beam 212a being blocked by the beam breakers 240 and 250 is less, the uniformity of the darker image can be improved.

It should be noted that the light attenuator 260 in FIG. 6 is disposed between the light integration rod 216 and the relay lens 218 for cutting into the transmission path of the light beam 212a between the light integration rod 216 and the relay lens 218. However, this light attenuator 260 can also be disposed at the other place in the illumination system 210, for example, between the color wheel 214 and the light integration rod 216.

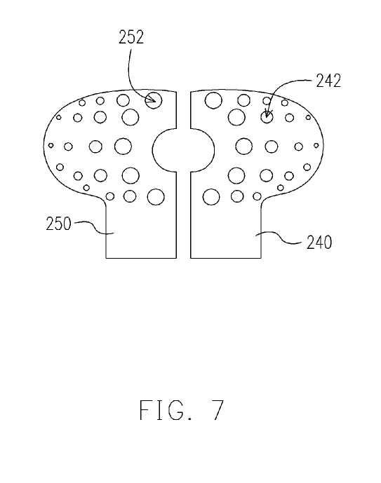

Referring to FIG. 3 and FIG. 7, in the foregoing optical projection apparatus 200, the beam breakers 240 and 250 can respectively have multiple holes 242 and 252. When the beam breakers 240 and 250 cut into transmission path of the light beam 212a, these holes 242 and 252 can let a portion of the light beam 212a pass. Therefore, the uniformity of the darker image can be improved.

It should be noted in the embodiment of the present invention that the beam breaker 240 with multiple holes 242, light source 212 with multiple output power, and the light attenuator 260 (shown in FIG. 6) can be individually used in the optical projection apparatus 200, simultaneously used in the optical projection apparatus 200, or used with any combination in the optical projection apparatus 200.

In sum, the optical projection apparatus of the present invention uses two beam breakers. During the period when optical projection apparatus projects a darker image, the two beam breakers can cut into the transmission path of the light beam from different directions to block a portion of the light beam. Therefore, the optical projection apparatus of the present invention can project a darker image with higher contrast and better uniformity. Also, since the angle θ for cutting in the projection lens unit 220 is not necessary to be large, the objective of significantly increasing the contrast is achieved. Therefore, the cutting portion of the projection lens unit 220 is less, and the risk for the projection lens unit 220 to be broken is reduced.

In addition, the optical projection apparatus can be implemented with light source with multiple output powers and/or the light attenuator, so that the light beam incident to the projection lens unit is reduced when the optical projection apparatus projects a darker image. As a result, the cutting portion of the projection lens unit becomes less, and the projection lens unit is not easy to be broken. Also, since the portion of the light beam bring blocked is less, the uniformity of the darker image can be further improved. In addition, the optical projection apparatus of the present invention can use the beam breaker with holes, such that a portion of the light beam can pass through the holes, and the uniformity of the darker image can be further improved.

It will be apparent to those skilled in the art that various modifications and variations can be made to the structure of the present invention without departing from the scope or spirit of the invention. In view of the foregoing descriptions, it is intended that the present invention covers modifications and variations of this invention if they fall within the scope of the following claims and their equivalents.

What is claimed is:

1. An optical projection apparatus, comprising:
an illumination system for providing a light beam;
a projection lens unit disposed on a transmission path of the light beam;
a reflective light valve disposed between the illumination system and the projection lens unit and on the transmission path of the light beam;
a first beam breaker; and
a second beam breaker, wherein the first beam breaker and the second beam breaker cut into the transmission path of the light beam from different directions to respectively block a portion of the light beam and let the other portion of the light beam pass.

2. The optical projection apparatus of claim 1, wherein the first beam breaker and the second beam breaker are disposed on the projection lens unit, and the first beam breaker and the second beam breaker cut into the transmission path of the light beam in the projection lens unit.

3. The optical projection apparatus of claim 1, wherein the first beam breaker and the second beam breaker are disposed in the illumination system, and the first beam breaker and the second beam breaker cut into the transmission path of the light beam in the illumination system.

4. The optical projection apparatus of claim 1, wherein the first beam breaker is disposed in the illumination system and cuts into the transmission path of the light beam in the illumination system, the second beam breaker being disposed on the projection lens unit and cutting into the transmission path of the light beam in the projection lens unit.

5. The optical projection apparatus of claim 1, wherein each of the first beam breaker and the second beam breaker comprises a plurality of holes.

6. The optical projection apparatus of claim 1, wherein the illumination system comprises a light source, and the light source comprises a plurality of output powers, wherein during a period when the first beam breaker and the second beam breaker cut into the transmission path of the light beam from different directions, the light source outputs a first power, the light source outputting a second power during the other period, the second power being larger than the first power.

7. The optical projection apparatus of claim 1, further comprising a light attenuator disposed in the illumination system, wherein the light attenuator cuts into the transmission path of the light beam in the illumination system.

8. The optical projection apparatus of claim 7, wherein the illumination system has a light integration rod and a relay lens, the light attenuator cutting into the transmission path of the light beam between the light integration rod and the relay lens.

9. The optical projection apparatus of claim 1, wherein the reflective light valve comprises a digital micro-mirror device (DMD) or a liquid crystal on silicon (LCOS) panel.

10. An optical projection apparatus, comprising:
an illumination system having a light source for providing a light beam, the light source having multiple output powers;
a projection lens unit disposed on a transmission path of the light beam;
a reflective light valve disposed between the illumination system and the projection lens unit and on the transmission path of the light beam; and
a beam breaker disposed on the projection lens unit, the beam breaker cutting into the projection lens unit to block a portion of the light beam, wherein during a period when the beam breaker cuts into projection lens unit, the light source outputs a first power, the light source outputting a second power during the other period, the second power being larger than the first power.

11. The optical projection apparatus of claim 10, further comprising a light attenuator disposed in the illumination system, the light attenuator cutting into the transmission path of the light beam in the illumination system.

12. The optical projection apparatus of claim 11, wherein the illumination system comprises a light integration rod and a relay lens, the light attenuator cutting into the transmission path of the light beam between the light integration rod and the relay lens.

13. The optical projection apparatus of claim 10, wherein the beam breaker has a plurality of holes.

14. The optical projection apparatus of claim 10, wherein the reflective light valve comprises a digital micro-mirror device (DMD) or a liquid crystal on silicon (LCOS) panel.

15. An optical projection apparatus, comprising:
an illumination system for providing a light beam;
a projection lens unit disposed on a transmission path of the light beam;
a reflective light valve disposed between the illumination system and the projection lens unit and on the transmission path of the light beam;
a beam breaker disposed on the projection lens unit, the beam breaker cutting into the projection lens unit to block a portion of the light beam; and
a light attenuator disposed in the illumination system, wherein the light attenuator cuts into the transmission path of the light beam in the illumination system.

16. The optical projection apparatus of claim 15, wherein the illumination system has a light integration rod and a relay lens, the light attenuator cutting into the transmission path of the light beam between the light integration rod and the relay lens.

17. The optical projection apparatus of claim 15, wherein the beam breaker has a plurality of holes.

18. The optical projection apparatus of claim 15, wherein the reflective light valve comprises a digital micro-mirror device (DMD) or a liquid crystal on silicon (LCOS) panel.

19. An optical projection apparatus, comprising:
an illumination system for providing a light beam;
a projection lens unit disposed on a transmission path of the light beam;
a reflective light valve disposed between the illumination system and the projection lens unit and on the transmission path of the light beam; and
a beam breaker disposed on the projection lens unit, wherein the beam breaker cuts into the projection lens unit to block a portion of the light beam, the beam breaker having a plurality of holes.

20. The optical projection apparatus of claim 19, wherein the reflective light valve comprises a digital micro-mirror device (DMD) or a liquid crystal on silicon (LCOS) panel.
